(19) United States
(12) Patent Application Publication
(10) Pub. No.: US 2005/0248501 A1
(43) Pub. Date: Nov. 10, 2005

(54) Multi display device

(76) Inventor: Si Han Kim, Kyunggi-Do (KR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(21) Appl. No.: 10/527,272

(22) PCT Filed: Sep. 16, 2003
(86) PCT No.: PCT/KR03/01888

§ 371 Date: Mar. 8, 2005

(30) Foreign Application Priority Data
Sep. 17, 2002 (KR) 10-2002-0056682
Sep. 23, 2002 (KR) 10-2002-0057667

(51) Int. Cl. G09G 5/00

(52) U.S. Cl. 345/1.1

(57) ABSTRACT

A multi display device includes panel housings having displays. The panel housings are foldable on each other and the displays are disposed adjacent to each other when the panel housings are unfolded. A key input part is further provided to be foldable on the panel housings. Accordingly, the multi display device is easy to grasp for the user while providing the folding/folding convenience.

### TECHNICAL FIELD

The present invention relates to a multi display device having a key input part that is foldable or slidable onto a panel housing having displays foldable on each other.

### BACKGROUND ART

To provide a large-sized screen, a technique forming a large-sized single screen using more than two displays has been developed. In recent years, as a variety of functions such as mobile Internet has been applied to a portable display, a need of the large-sized screen has been increased. However, when the portable display is designed having the large-sized screen, it deteriorates the mobility that is a major feature of the portable display. Therefore, a portable display device having flat displays that are designed to be folded on each other has been proposed.

Generally, flat displays such as LCDs, FEDs (Field Emission Display), PDPs (Plasma Display Panel), and ELs (Electro Luminescent) and the like have been used for the portable display device.

Such a portable foldable display device applying a flat display uses a pen type input device disposed on a top of the display. However, when the flat displays are designed to be folded on each other, the pen type input device should be specially designed to be appropriate to the foldable displays. In addition, when a key input device is employed, the size of the display device is enlarged, deteriorating the portability.

### SUMMARY OF THE INVENTION

Therefore, the present invention has been made in an effort to solve the above-described problems of the prior art.

It is an objective of the present invention to provide a multi display device including panel housings each having a foldable display and a key input part, the panel housing and the key input part being designed to be horizontally folded and unfolded or slid into each other when the panel housings are vertically adjacent to each other.

To achieve the above objective, the present invention provides a multi display device comprising panel housings having displays, the panel housings being foldable on each other, at lease one side of the displays being disposed adjacent to each other when the panel housings are unfolded; and a key input part foldable on the panel housings.

A gearing device or an elastic device is used to unfold the key input part from the panel housings or unfold the panel housings from each other. When the key input part is unfolded from the panel housings, the panel housings are unfolded from each other.

The multi display device may further comprise a first sub-display formed on an outer surface of one of the panel housings folded on the key input part, and a second sub-display formed on an inner surface of one of the panel housings unfolded from the key input part,

Information is display on the second sub-display by an input function provided on the key input part, and the second sub-display is driven when the key input part is unfolded from the panel housings folded from each other.

The multi display device may further comprise cover means for covering a side folding portion of the panel housings, the cover means being provided on a side of the key input part where a folding portion of the panel housings is mounted.

The multi display device may further comprise an expanding part provided on the key input part, the expanding part being separately coupled on the key input part.

According to another aspect of the present invention, a multi display device comprises at least two panel housings with displays, the panel housings being foldable on each other, at least one side of the displays being disposed adjacent to each other when the panel housings are unfolded; and a key input part insertable into a lower portion of the panel housings by a sliding motion.

The sliding motion of the key input part synchronizes with a folding/unfolding operation of the panel housings. The key input part slides out when the panel housings are unfolded from each other.

The multi display device may further comprise a sub-display formed on an outer surface of the panel housing, and an expanding part separately coupled on the key input part.

The panel housings are overlapped on each other or spread from each other by a relative sliding motion, and when the panel housings are spread, at least one side of the displays are disposed adjacent to each other.

The panel housing are detachable coupled to each other, and when the panel housings are coupled to each other, at least one side of the displays are disposed adjacent to each other.

The multi display device may further comprise a support for enhancing supporting force between the key input part and the panel housings when the key input part slides out of the panel housings. The support is designed slide between the panel housings and the key input part or designed in more than two steps so that they can be overlapped.

According to another aspect of the present invention, a multi display device comprises at least two panel housings with displays, the panel housings being foldable on each other, at least one side of the displays being disposed adjacent to each other when the panel housings are unfolded; a key input part; and means for moving the displays to a center of the key input part when the displays are sided to one side of the key input part when the key input part and the displays are unfolded from each other.

The panel housings and the key input part are moved by a folding/unfolding operation or a relative sliding motion.

The displays are folded such that rear surfaces of the displays contact each other and designed to be adjacent to each other or separated from each other.

According to still another aspect of the present invention, a multi display device comprises at least two panel housings with displays, the panel housings being foldable on each other, at least one side of the displays being disposed adjacent to each other when the panel housings are unfolded; a key input part; and a connection joint portion formed on a sidewall of the panel housing to which the displays adjacent or an adjacent portion of a frame to which the displays adjacent so as to dispose the displays to be adjacent to each other.

The connection joint portion is opened, and the thickness of the connection joint portion is less than 0.5 mm.

A sidewall of the panel housings where the displays are adjacent to each other is cut away to defining a cutting portion and the displays are mounted on the upper end of the cutting portion.

After mounting the displays on the panel housings, a protecting cover is disposed to protect the connection joint portion of the panel housing and a front of a screen. The protecting cover has a side protecting part for protecting the connection joint portion of the panel housings and a front protecting part for protecting the front of the screen, the side protecting part being thinner than the front protecting part.

The thickness of the side protecting part is less than 0.5 mm.

### BRIEF DESCRIPTION OF THE DRAWINGS

FIGS. 1a and 1b views illustrating a multi display device according to an embodiment of the present invention;

FIG. 2 is a view illustrating an opposite side of cover means in a panel housing.

FIGS. 3a and 3b are views illustrating an embodiment where a gearing device is used as means for folding and unfolding the panel housing;

FIG. 4 is a block diagram of a multi display according to the present invention;

FIGS. 5a and 5b are views illustrating an embodiment where a sub-display is employed;

FIG. 6 is a flowchart illustrating a process for using a sub-display;

FIGS. 7a and 7b are views illustrating another embodiment of cover means;

FIG. 8 is a view illustrating an embodiment where an expanding part is employed;

FIGS. 9a and 9b are views illustrating a display having a key input part movable in a sliding motion according to the present invention;

FIGS. 10a and 10b are views illustrating a sliding principle by a power system;

FIG. 11 is a block diagram of the present invention depicted in FIGS. 9a and 9b;

FIG. 12 is a flowchart for controlling a gearing device;

FIG. 13 is a view illustrating an embodiment where a panel housing is opened synchronizing with the movement of a key input part;

FIG. 14 is a view illustrating another embodiment where a panel housing is synchronized with a key input part;

FIG. 15 is a view illustrating an embodiment with a sub-display;

FIG. 16 is a view illustrating an embodiment with a panel housing movable in a sliding motion;

FIGS. 17a and 17b are views illustrating an embodiment where an expanding part is coupled on a key input part;

FIG. 18 is a view illustrating another embodiment of sliding means;

FIG. 19a to 19c are views illustrating an embodiment with a support between a key input part and a panel housing;

FIGS. 20a to 20c are views illustrating another embodiment of a support;

FIGS. 21a and 21b are views illustrating an embodiment for moving a display to a movable connection part;

FIGS. 22a and 22b are views illustrating a sliding principal of an unfolded display;

FIG. 23a and 23b are views illustrating an embodiment where a display moved toward a middle portion when a key input part slides;

FIGS. 24a and 24b are views illustrating an embodiment where displays are folded such that their rear surfaces face each other;

FIGS. 25a and 25b are views illustrating another embodiment where displays are folded such that their rear surfaces face each other;

FIG. 26 is a view of a display mounted in a panel housing;

FIG. 27 is a view of a panel housing with a display and a protecting cover;

FIGS. 28a to 28c are views illustrating a frame;

FIGS. 29a and 29b are views illustrating a connection joint portion of a panel housing and a frame.

### EMBODIMENTS

Preferred embodiments of the present invention will be described hereinafter in conjunction with the accompanying drawings.

As a flat display used in the present invention, LCDs, FEDs, PDPs and electric papers et al may be used.

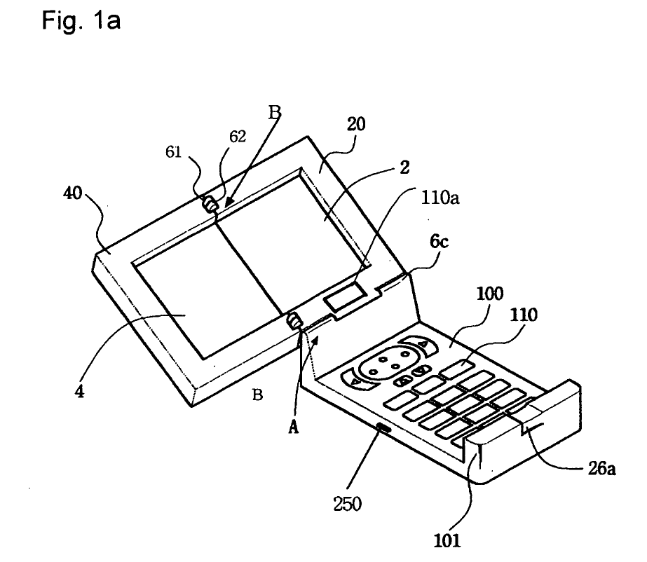

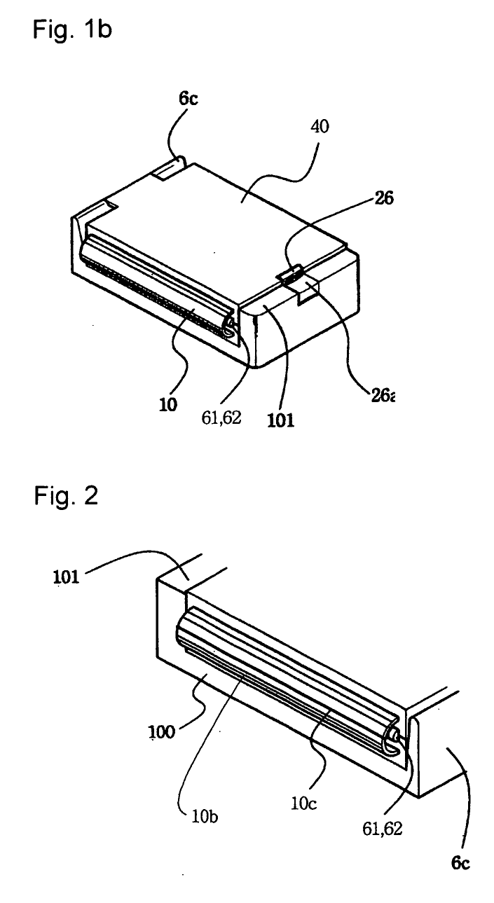

FIGS. 1a and 1b are views illustrating a multi display device of the present invention. The multi display device comprises displays 2 and 4 provided in panel housings 20 and 40 such that the displays 2 and 4 are disposed adjacent to each other when the panel housings 20 and 40 are unfolded; and a key input part 100 independently formed from the panel housings 20 and 40.

FIG. 1a shows a state where the panel housings and the key input part are unfolded.

The key input part 100 and the panel housings 20 and 40 are designed to be horizontally folded on each other by a connecting part 6c as viewed from the drawing. The panel housings 20 and 40 are designed to be vertically folded by connecting means 61 and 62. The key input part 100 is provided with an input device 110 so as to make it possible to input information.

The key input part 100 and the panel housings 20 and 40 are designed to maintain a predetermined angle even when they are fully unfolded. That is, the predetermined angle provides a user with a convenience in seeing the display.

In addition, the present invention may further comprises a pen-type input device 110a.

FIG. 1b shows a view illustrating a multi display device that is in a folded state.

After the panel housings 20 and 40 are folded on each other, the folded panel housings 20 and 40 are further folded on the key input part 100 as shown in FIG. 1b.

A handle 26 is formed on a rear side of the panel housing 40, and the key input part 100 is provided with a handle button 26a for holding the handle 26. The handle button 26a is withdrawn when holding the handle 26, and is restored to its initial position due to its elastic force. Furthermore, supports 101 are formed on both sides of the handle button 26a to level the handle button 26a. Cover means 10 is provided on a portion where the panel housings 20 and 40 are folded.

FIG. 2 shows a view illustrating an opposite side of the cover means in the panel housing.

To make an appearance balance on both sides of the display, imitated cover means 10b identical to the cover means 10 in their shape is also provided on the side where the cover means 10 is not provided. The imitated cover means 10b is divided into upper and lower halves by a separating line 10c. The separating line 10c divides the panel housings 20 and 40.

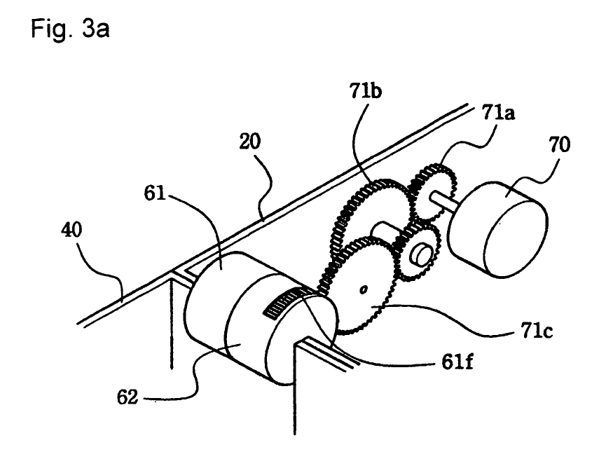

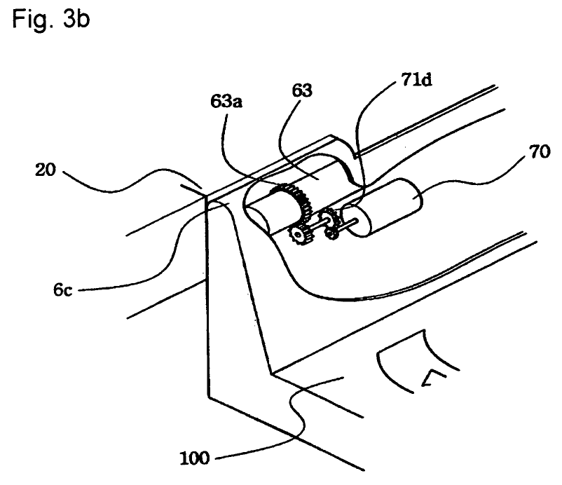

FIGS. 3a and 3b are views illustrating an embodiment where a gearing device is used as means for folding and unfolding the panel housings.

FIG. 3a shows a view of a power transmission part for folding and unfolding the panel housings 20 and 40, which is provided in a section B of FIG. 1a.

Power generated through the gearing device 70 is transmitted to a connection gear 61f provided on connecting means 61 and 62 through an adjusting gear 71a, 71b and 71c for adjusting speed. A switch 250 is provided on a side of the key input part 100 to operate the gearing device 70.

At this point, the gearing device 70 is provided on a first panel housing 20 and a first connection means 61 is also connected to a first panel housing 20. A second connection means 62 mounted on the connection gear 61f is fixed on a second panel housing 40. Accordingly, when the switch 250 is turned on, the power of the gearing device 70 moves the connection gear 61f of the second connection means 62, as a result of which the first and second panel housings 20 and 40 are folded or unfolded.

The gearing device provided in FIG. 3b is equipped on a section A of FIG. 1a.

When operating the switch 250, the power of the gearing device 70 is transmitted to a connection gear 63 provided on a connection shaft 63 of the connection part 6c through an adjusting gear 71d for adjusting speed.

The connection shaft 63 is connected one of the first and second panel housings 20 and 40. Therefore, the key input part 100 and the panel housings 20 and 40 are folded or unfolded by the power transmitted from the gearing device 70.

At this point, the gearing device 70 in FIG. 3a may be formed of a spiral spring for storing elastic force. The spiral spring is designed to store elastic force when the panel housings 20 and 40 are folded.

Accordingly, when the key input part 100 and the panel housings 20 and 40 are unfolded, the panel housings 20 and 40 are automatically unfolded by the elastic force of the spiral spring. That is, when the key input part 100 and the panel housings 20 and 40 are manually unfolded, the panel housings 20 and 40 are automatically unfolded by the elastic force of the spiral spring. At this point, the energy for unfolding the panel housings 20 and 40 becomes the elastic force stored when the panel housings 20 and 40 are folded.

In addition, the gearing device 70 shown in FIG. 3b is also formed of a spiral spring so that the panel housings 20 and 40 and the key input part 100 can be automatically unfolded from each other. There is provided locking means for fixing the panel housings 20 and 40 on the key input part 100. When the locking means is released, the panel housings 20 and 40 and the key input part 100 are unfolded by the elastic force of the spiral spring.

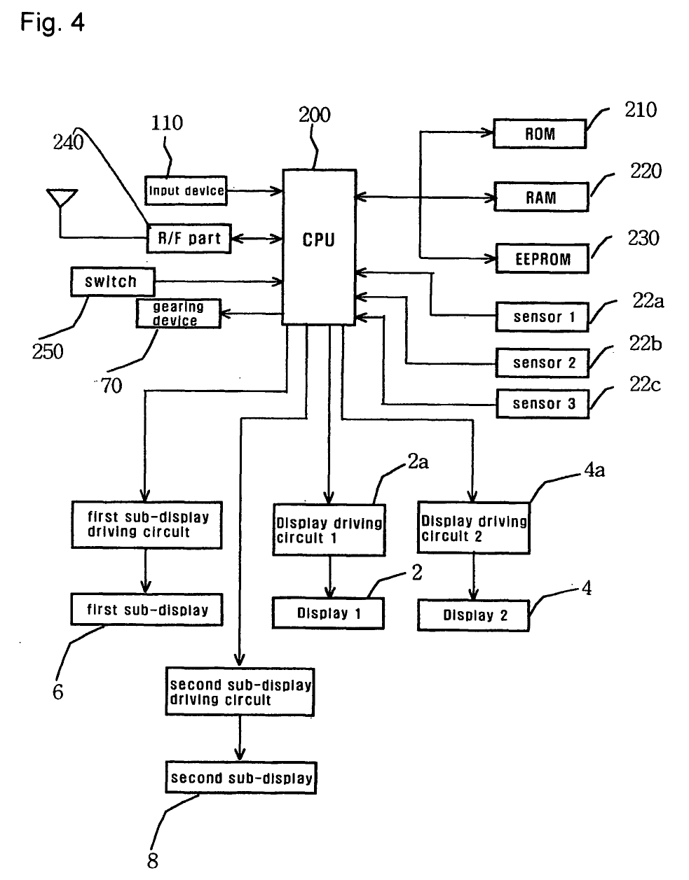

FIG. 4 shows a block diagram of a multi display according to the present invention.

The display is provided with a sensor 3(22c) on the connection shaft 63 or the connection part 6c so that the sensor 3(22c) can detect unfolded state when the key input part 100 and the panel housings 20 and 40 are unfolded at a predetermined angle.

When the key input part 100 and the panel housings 20 and 40 are unfolded at the predetermined angle, a sensor 1(22a) detects this state and transmits the detected signal to a central process unit 200 so that the central process unit 200 operates the gearing device 70 provided on the panel housing 20.

That is, when the key input part 100 and the panel housings 20 and 40 are unfolded at a predetermined angle, the gearing device 70 is driven to unfold the panel housings 20 and 40 from each other. At this point, the unfolding of the key input part 100 from the panel housings 20 and 40 is manually realized.

In addition, as shown in FIG. 3b, by providing the transmission device 70 on the key input part 100, the unfolding of the key input part 100 from the panel housings 20 and 40 could be also automatically realized. In this case, the unfolding of the key input part 100 and the panel housings 20 and 40 are performed by manipulating a switch 250. In addition, when the key input part 100 and the panel housings 20 and 40 are unfolded from each other at a predetermined angle, the gearing device 70 mounted on the panel housing 20 is driven by the sensor 3(22c) to unfold the panel housings 20 and 40 from each other.

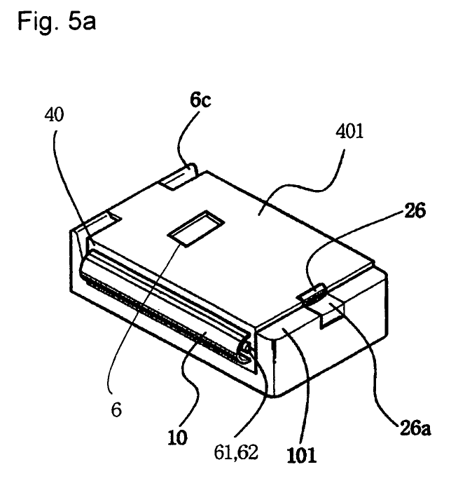

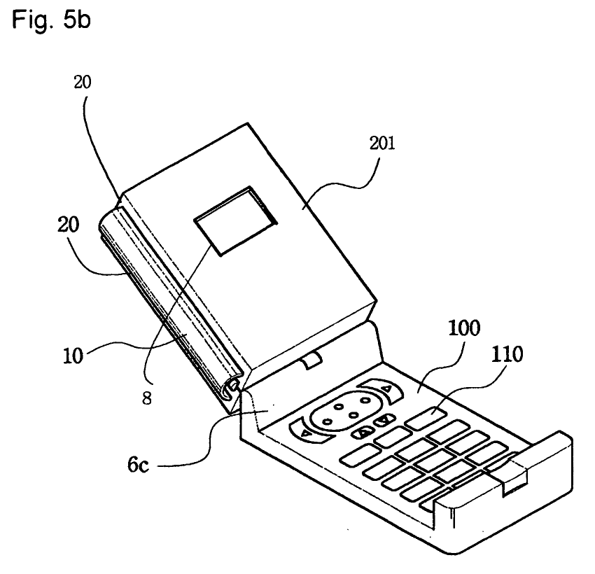

FIGS. 5a and 5b show an embodiment provided with a sub-display.

FIG. 5a shows a first sub-display 6 that is used in a state where the panel housings 20 and 40 and the key input part 100 are all folded. As shown in the drawing, in a state where the panel housings 20 and 40 and the key input part 100 are folded, the first sub-display 6 is formed on an outer surface exposed externally. The sub-display displays a status of the multi display device.

FIG. 5b shows a second sub-display 8 that is used in a state where the key input part and the panel housings are unfolded. As shown in the drawing, although the key input part 100 is unfolded from the panel housings 20 and 40, when the panel housings 20 and 40 are still folded on each other, an inner surface 201 is exposed. At this point, the second sub-display 8 is formed on the inner surface 201. Here, the second sub-display 8 is more elevated from the inner surface 201, a surface of the key input part 100 on which the input device 110 is provided and which contacts the second sub-display 8 can be designed to be lowered.

In addition, when the second sub-display 8 is used, a function for automatically unfolding the panel housings 20 and 40 from each other when the key input part 100 is unfolded from the panel housings 20 and 40 is not provided.

The second sub-display 8 displays information input through the input device 110 and displays required information in accordance with the order from the input device 110. That is, when the device is used as a mobile phone, simple letters or information search can be possible through the second sub-display 2.

Meanwhile, when the user intends to use complicated functions such as a game, Internet, and an electronic pocket book, the displays 2 and 4 appeared when the panel housings 20 and 40 are unfolded from each other are used.

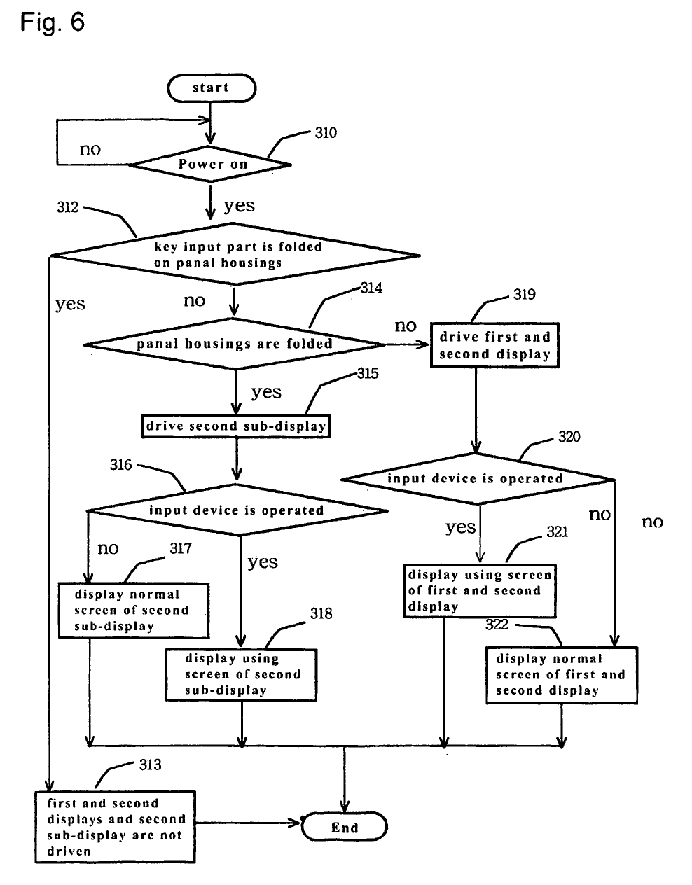

FIG. 6 shows a flowchart illustrating a using process of the sub-display.

When electric power is turned on, the central process unit 200 identifies the status of memories 210, 220 and 230, the input device 110 and the sensors 22a and 22b, and outputs a signal for driving the display in accordance with predetermined information.

Afterwards, the sensor 1(22a) detects if the panel housings 20 and 40 are folded on each other, and the sensor 2(22b) detects if the key input part 100 is folded on the panel housings 20 and 40 (Step 312).

When it is determined that the key input part 100 and the panel housings 20 and 40 are all folded in Step 312, the first and second displays 2 and 4 and the second sub-display are not driven (Step 313).

When all of the key input part 100 and the panel housings 20 and 40 are not all unfolded in Step 312, it is determined if the panel housings 20 and 40 are folded (Step 314). And if the panel housings 20 and 40 are folded, the second sub-display 8 is driven (Step 315).

Meanwhile, when the input device 110 is operated, a using screen is displayed on the second sub-display 8, and when it is not operated, a normal screen is displayed on the same (Steps 316-318).

In addition, when the panel housings are unfolded in Step 314, the first and second displays 2 and 4 are driven (Step 319).

Here, when the input device 110 is operated, a using screen of the first and second displays is displayed, and it is not operated, a normal screen of the same is displayed (Steps 320-322).

In the multi display device of the present invention, a display screen for the second sub-display 8 and a display screen for the first and second displays 2 and 4 are different from each other. Therefore, the flowchart depicted in FIG. 6 shows that the display screen can be selected in accordance with each case.

In addition, the first sub-display is designed to be always driven regardless of the determinations in Steps 312 and 314. To drive the first sub-display 6, a specially prepared switch can be provided. Furthermore, only one of the first and second displays 2 and 4 may be driven through a selection of a menu button or special switch in a state where the panel housings 20 and 40 are unfolded from each other.

As described above, the driving of the displays can be selectively done in automatic or manual modes, thereby reducing the consumption of the power.

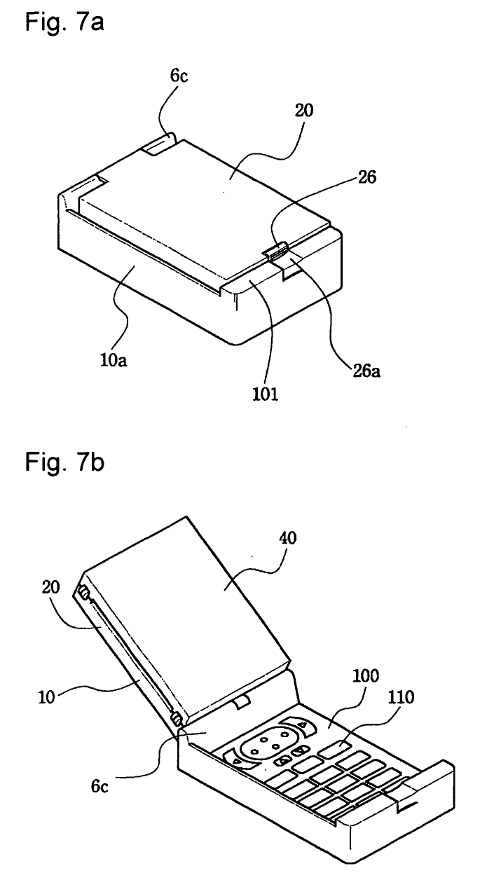

FIGS. 7a and 7b show another embodiment of the cover means.

FIG. 7a shows a state in which the key input part 100 and the panel housings 20 and 40 are all folded on each other, and FIG. 7b shows a state in which the panel housings 20 and 40 are folded on each other.

As shown in the drawings, fixed cover means 10 is provided on a side of the key input part mounted on a portion where the panel housings 20 and 40 are folded. The fixed cover means 10a covers the side of the folding sides of the panel housings 20 and 40. That is, when the folded panel housings 20 and 40 are folded on the key input part 100, the fixed cover means 10a covers the side of the folding portions of the panel housings.

The fixed cover means 10a is designed to be protruded from the side of the key input part 100. However, an elastic member may be further provided on a lower portion of the fixed cover means 10a so as not for the fixed cover means 10a to be protruded from the key input part 100. That is, the fixed cover means 10a can be designed to be received in the key input part 100.

Meanwhile, since the displays 2 and 4 are disposed adjacent at their one side to each other at the folding portions of the panel housings 20 and 40, the one side of the displays 2 and 4 are exposed or closed by a thin protecting film. Accordingly, in order to cover the folding portions of the displays 2 and 4, there is a need for providing cover means 10. The cover means should be designed to synchronize with the folding/unfolding operation of the panel housings 20 and 40. However, in this embodiment, as shown in FIG. 7, since the fixed cover means 10a is provided on the side of the key input part, the folding portions of the panel housings 20 and 40 can be protected with a simple structure.

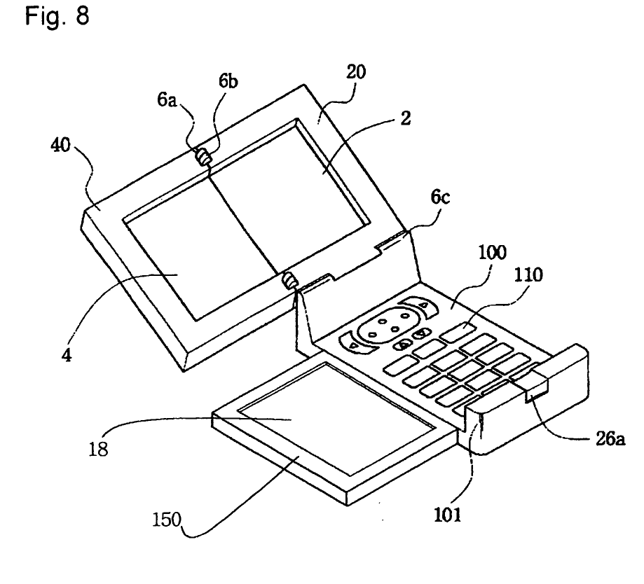

FIG. 8 shows an embodiment having an expanding part.

As shown in the drawing, an expanding part can be mounted on a side of the key input part 100. The expanding part 150 is detachably mounted. That is, it can be used by being detached from the key input part 100. In addition, a pen input device 18 can be further provided on the expanding part 150. An additional display may be further provided on a lower end of the pen input device 18. An expandable memory and a battery may be further mounted on the expanding part 150, thereby further improving the function of the portable multi display device.

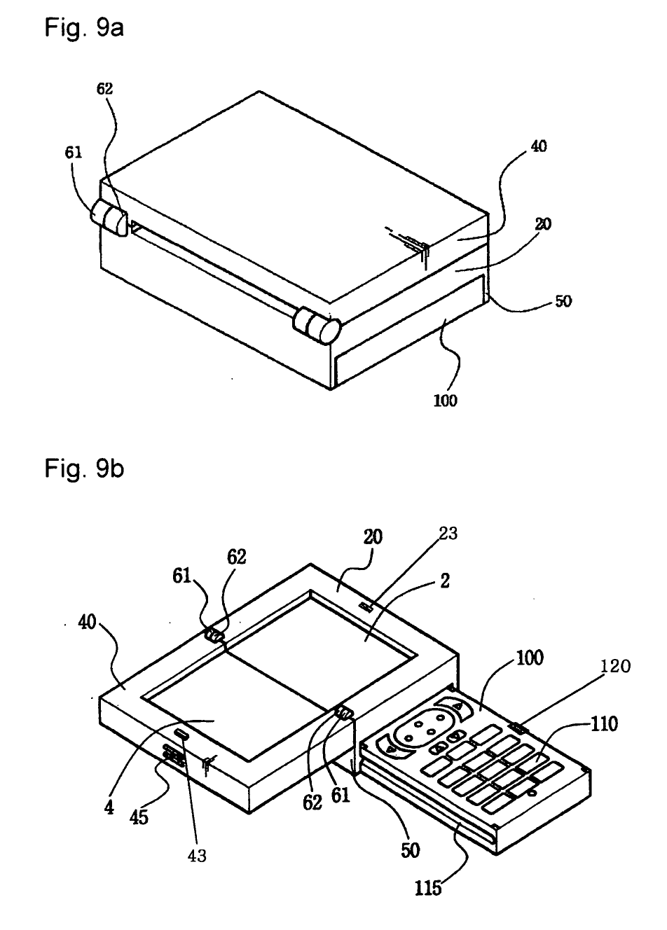

FIGS. 9a and 9b show a display in which the key input part moves in a sliding motion.

In this embodiment, the key input part is received in a lower portion of the panel housing in a sliding motion. The key input part slides in a perpendicular direction to a direction where the displays disposed adjacent to each other.

FIG. 9a shows a state where the panel housings 20 and 40 are folded and the key input part 100 is received in a housing 50 formed on a lower portion of the panel housing. FIG. 9b shows a state where the panel housings 20 and 40 are unfolded and the key input part 100 is withdrawn out of the panel housing 20 and 40 in the sliding motion.

The key input part 100 is provided with sliding means 115 formed in a groove shape so as to slide into or out of a housing 50 formed on a lower portion of the panel housings 20 and 40. The key input part 100 is further provided with an input device 110 and a key input groove 120.

Meanwhile, a handle 45 is formed on a side of the panel housings 40 so as to make it easy to unfold the panel housings 20 and 40. The folding state of the panel housings 20 and 40 are stably maintained by a fixing projection 43 and a fixing groove 23.

In this embodiment, when the panel housings 20 and 40 are unfolded, means for allowing the key input part 100 to automatically sliding out of the housing 50 is provided.

As shown in the drawing, since the key input part 100 slides in a direction perpendicular to a direction where the displays 2 and 4 are adjacent each other, the overall shape of the portable multi display device can be formed in a laterally-long-shape so that the user can easily grasps the multi display device.

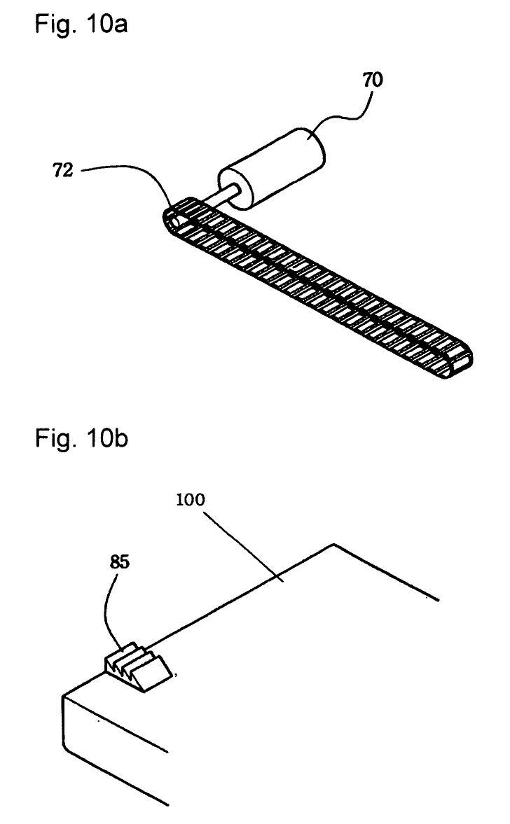

FIGS. 10a and 10b show a principle of the sliding movement by a power device.

The power device 70 is formed of a spiral spring storing elastic energy and connected to the power transmission means 72. In addition, a saw teeth gear 85 formed on an upper end of the key input part 100 shown in FIG. 10b is connected with the power transmission means 72.

As shown in FIG. 9b, when the key input part 100 slides into the housing 50 by a finger pushing the same, the spiral spring of the power device 70 stores the elastic force by the power transmission means 72 connected to the saw teeth gear 85 of the key input part 100. At this point, when a locking device is provided, the key input part 100 received in the housing 50 can be fixed. When the locking device is released, the key input part 100 slides out of the housing 50 by the elastic force stored in the spiral spring.

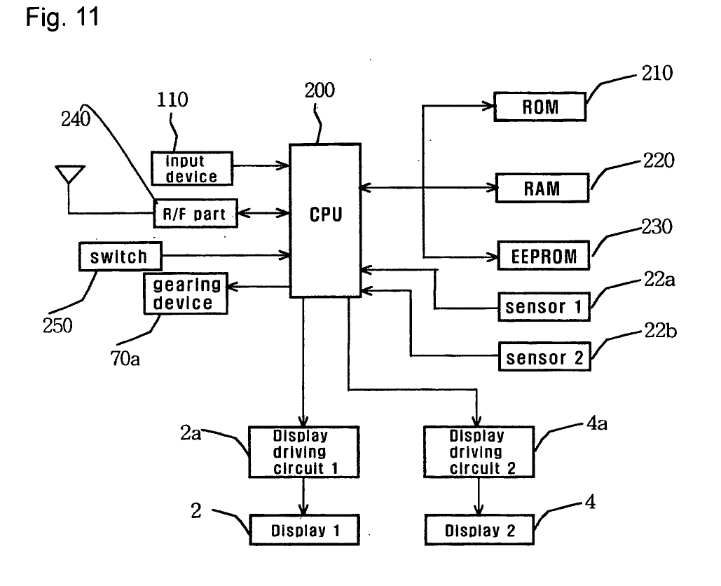

FIG. 11 shows a block diagram of the present invention depicted in FIGS. 9a and 9b.

The multi display device is comprised of a central process unit 200, ROM 210, EEP ROM 220, an input device 110, and an R/F part 240. The central process unit 200 controls the drive of a display driving circuit 1(2a) and a driving circuit 2 (4a), thereby driving the display 1(2) and the display 2(4).

Sensors 1 and 2(22a)(22b) are further provided. The sensor 1(22a) detects the coupling state of the panel housings 20 and 40, and the sensor 2(22b) detects the received state of the key input part 100. The detecting signals of the sensors 22a and 22b are transmitted to the central process unit 200. The power device 70 is operated in accordance with the detecting signals. Here, the sensor 1(22a) is provided on the fixing groove 23 formed on the panel housing 20, and the sensor 2(22b) is provided in the housing 50. Particularly, the sensor 2(22b) is provided on a lower side of the housing and above the key input part 100.

The power device 70 is formed of the spiral spring in the embodiment of FIG. 10a. However, the power device 70 that is driven by the sensors 22a and 22b may be formed of a gearing device that will be located on the same location as that where the power device of FIG. 10a is located.

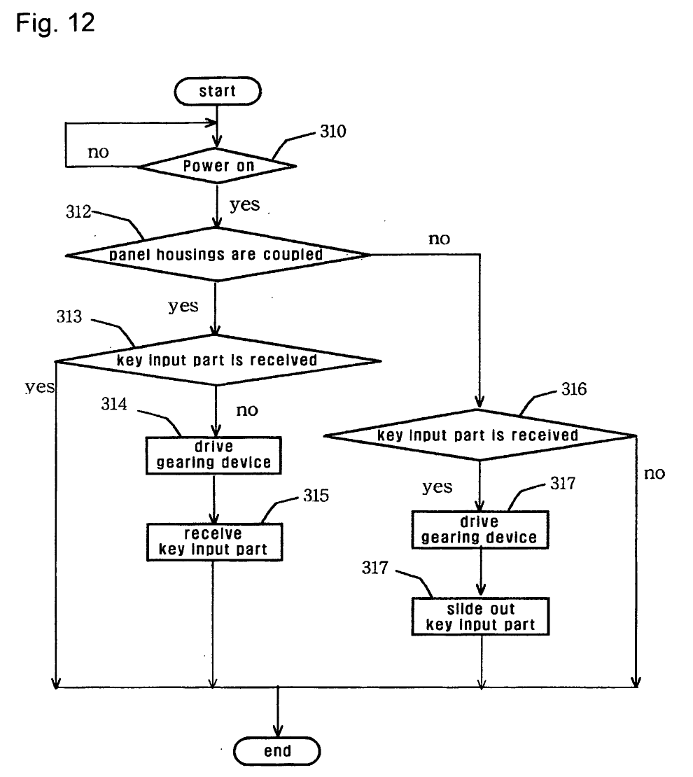

FIG. 12 is a flowchart for controlling the gearing device.

When a user turns on the power switch, the frequency signal from the antenna is transmitted to the central process unit 200 through the R/F part 240. Then, when a specific function is set through the input device 110, the central process unit 200 performs the specific function set through the input device 110 to output a signal for driving the displays 2 and 4 to the display driving circuits 2a and 4a. In addition, the sensors 1 and 2(22a)(22b) detect the panel housing coupling state and the key input part received state. The detected signals are output to the central process unit 200.

First, it is determined by the sensor 1(22a) if the panel housings 20 and 40 are coupled (Step 312).

When the panel housings 20 and 40 are coupled, it is determined by the sensor 2(22b) if the key input part 100 is received in a lower portion of the panel housings 20 and 40 (Step 313). When the key input part 100 is received, the gearing device 70a is not operated. When the key input part 100 is not received, the gearing device 70a is driven to receive the key input part 100 (Steps 314-315).

In addition, even when the panel housings 20 and 40 are not coupled, it is determined by the sensor 2(22b) if the key input part 100 is received in the lower portion of the panel housings 20 and 40 (Step 316). When the key input part 100 is not received, the gearing device is not driven, and when received, the same is driven to slide the key input part 100 out of the panel housings 20 and 40 (Steps 317-318).

According to the above-described flowchart, when the panel housings 20 and 40 are closed, the key input part 100 is received in the lower portion of the panel housings 20 and 40, and when opened, the same is withdrawn out of the panel housings 20 and 40.

Meanwhile, it is possible that the panel housings 20 and 40 maintains the closed state when the key input part 100 slides out of the lower portion of the panel housings 20 and 40. It is also possible that when the key input part 100 is received, the panel housings 20 and 40 are folded, and when withdrawn, the panel housings are unfolded.

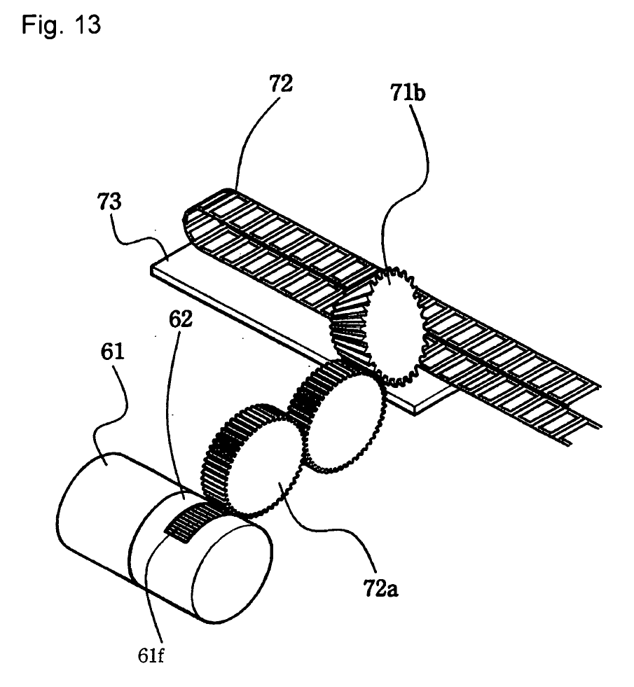

FIG. 13 shows an embodiment where the panel housings are opened synchronizing with the sliding of the key input part.

As shown in the drawing, the linear motion of the power transmission means 72 is converted into a rotational motion by an adjusting gear 71b, and is then transmitted to a connection shaft gear 61f formed on the connection means 62 through a connection gear 72a. The power transmission means 72 is connected to the saw teeth gear 85 of the key input part 100 through a connection plate 73. Meanwhile, the connection plate 73 is designed to transmit only linear motion among the motions of the key input part 100 to the power transmission means 72. Other parts of the power transmission means 72 that are omitted in the drawing is identically connected to other connecting means 61 and 62.

At this point, the gearing device 70a is connected to the connection shaft gear 61f or the power transmission means 72, and the sensor is provided to detect the received state of the key input part 100. By detecting the key input part 100 that is manually moved, the panel housings 20 and 40 are opened and closed using the gearing device. Such an operational principle can be possible by applying the flowchart depicted in FIG. 4. In this case, it is possible that the key input part 100 is not connected to the power transmission means 72.

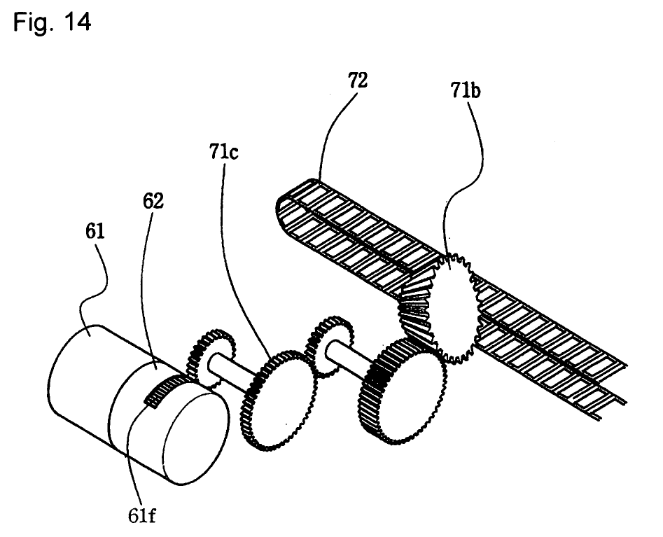

FIG. 14 shows a view illustrating an embodiment where the panel housings are moved synchronizing with the key input part.

A speed adjusting gear 71c and the adjusting gear 71b for converting the linear motion into the rotational motion are disposed between the power transmission means 72 and the connection shaft gear 61f so that the motion of the key input part 100 can synchronize with the folding/unfolding motion of the panel housings 20 and 40.

That is, by the adjustment by the speed adjusting gear 71c, the key input part 100 is completely withdrawn while the connection means 61 and 62 rotates by 180 degrees. Accordingly, when the panel housings 20 and 40 are closed, the key input part 100 is also received, and when opened, the same is withdrawn. In addition, a handle may be attached on the key input part 100 so that the key input part 100 can be moved by the handle. That is, when the key input part 100 slides into panel housings 20 and 40, the panel housings 20 and 40 are closed, and when slides out, the same are opened.

When the gearing device 70a is connected to the power transmission device 72, the gearing device 70a can be operated by the switch 250 depicted in FIG. 11.

That is, by a stroke of switch operation, the panel housings 20 and 40 can be opened while sliding the key input part 100 out of the panel housings. Likewise, by a stroke of switch operation, the panel housings 20 and 40 are closed while sliding the key input part into the panel housings.

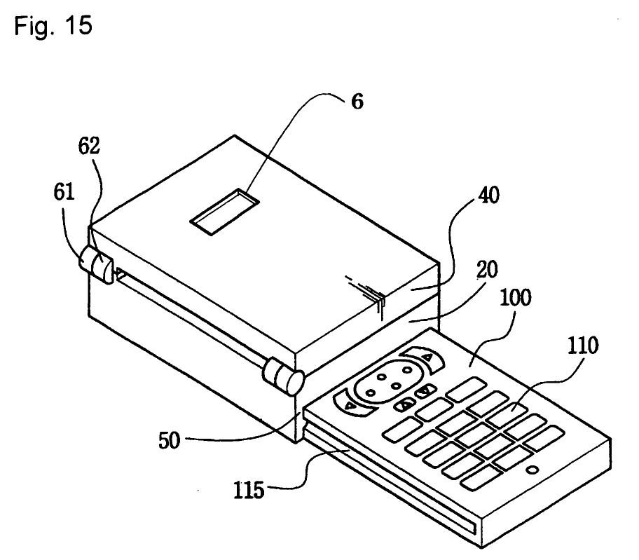

FIG. 15 is a view illustrating an embodiment where a sub display is provided on the display.

As shown in FIG. 15, the sub-display 6 can be provided on an outer portion of the panel housing 40. The status of the multi display device of the present invention can be identified through the sub-display 6 even when the panel housings 20 and 40 are closed.

In a state where the panel housings 20 and 40 are closed, when the key input part 100 slides out of the panel housing, only the sub-display 6 is driven to use the multi display device. In this case, when the closing of the panel housings 20 and 40 is detected by the sensor, only the sub-display 6 is driven.

When the sub-display 6 is provided, and the panel housings 20 and 40 are unfolded, the key input part 100 slides out. However, when the key input part 100 slides out, the panel housings 20 and 40 are not unfolded.

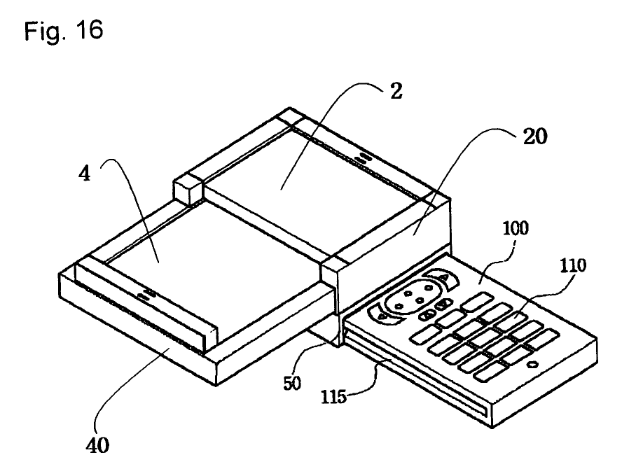

FIG. 16 shows another embodiment having panel housings moving in a sliding motion.

By designing the panel housings 20 and 40 to be slidable, the panel housings are overlapped on each other or spread. When the panel housings are spread, the displays mounted on the panel housings 20 and 40 are disposed adjacent to each other.

In addition, the sliding direction of the key input part 100 is perpendicular to the adjacent direction of the displays so that it is easy to grasp the multi display device.

The sliding the key input part 100 in and out of the lower portion of the panel housing can be applied to a device where the panel housings 20 and 40 are coupled to or separated from each other to increase or reduce the screen size.

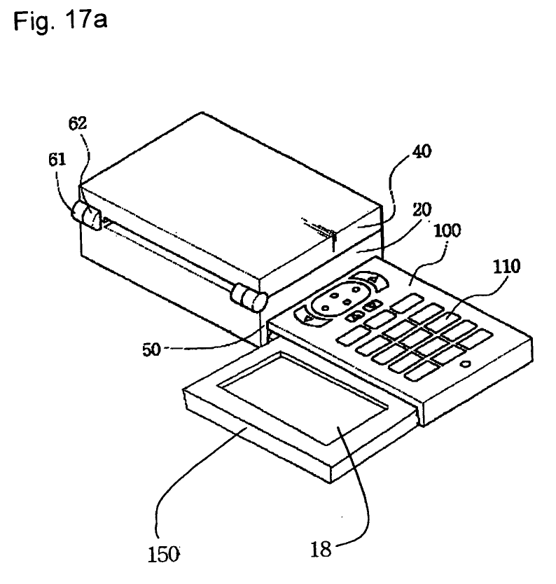

FIGS. 17a and 17b show an embodiment where an expanding part is coupled on the key input part.

As shown in the drawing, the expanding part can be coupled on a right or left side of the key input part 100. The expanding part 150 is a pen input device 18. A display may be further provided on a lower end of the pen input device 18. Additional memories or electric power devices may be further mounted in the expanding part, thereby improving the function of the multi display device.

FIG. 17a show an embodiment where the expanding part 150 is provided on the key input part 100 provided on the lower portion of the panel housings 20 and 40 that is capable of the folding/unfolding operation. FIG. 17b show an embodiment where the expanding part 150 is provided on the key input part 100 provided on the lower portion of the panel housings 20 and 40 that are separated or coupled to each other, or slid to each other.

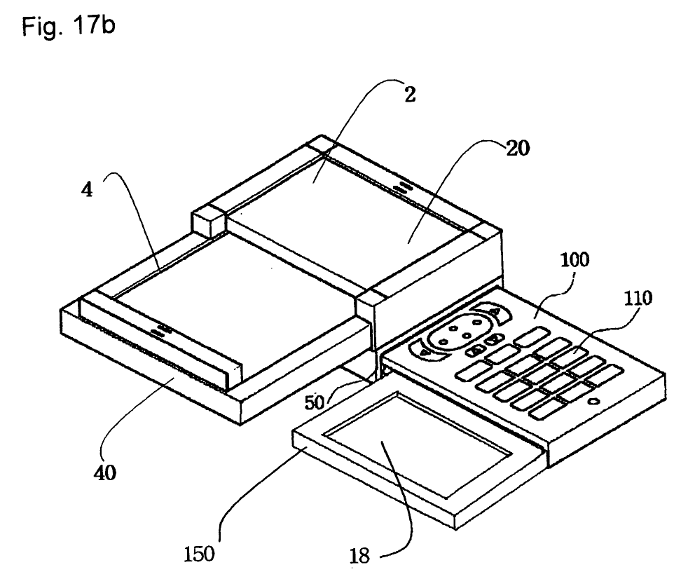

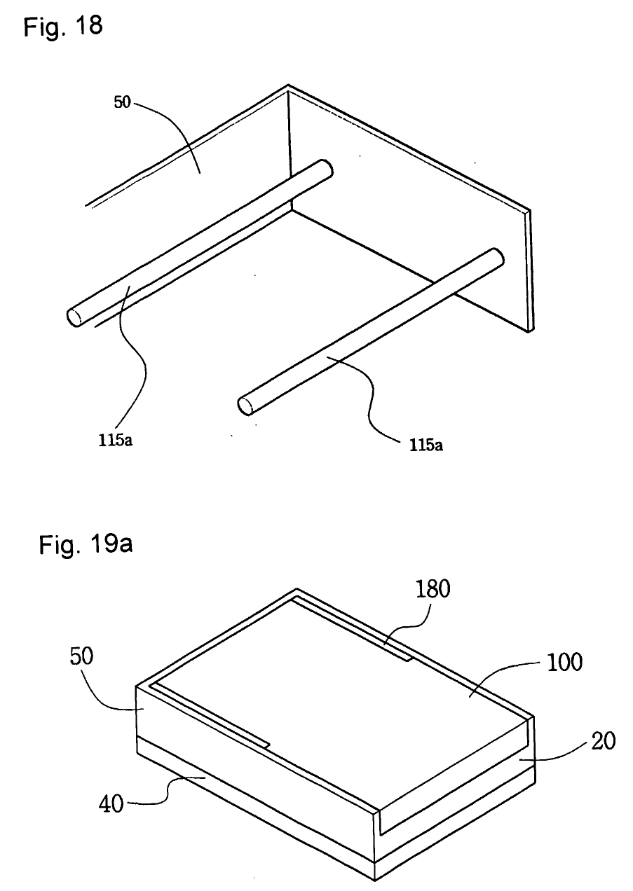

FIG. 18 shows another embodiment of the sliding means.

As shown in FIG. 9b, the sliding means 115 is formed of a groove or a projection formed on the key input part 100. However, in this case, the outer shape of the key input part 100 should be changed and the groove or projection causes the collection of alien substances. To solve this problem, as shown in FIG. 18, a sliding bar 115a is provided in the housing 50 and the key input part 100 is provided with a hole in which the sliding bar 115a is inserted so that the key input part 100 can slide.

Although being omitted in the drawing, hooking means for preventing the key input part 100 from completely removing from the housing 50 may be provided on a distal end of the sliding bar 115a, an inner portion of the key input part 100, or the housing 50.

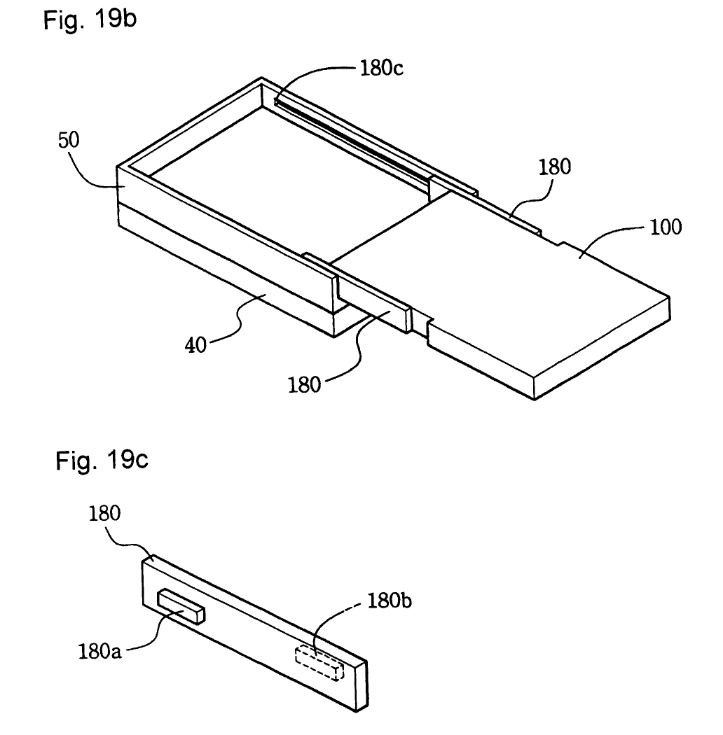

FIGS. 19a to 19c show an embodiment where a support is provided between the key input part and the panel housing.

FIG. 19a shows a view illustrating the key input part 100 received in the housing 50, and FIG. 19b shows a view illustrating the key input part 100 withdrawn out of the housing 50. When the key input part 100 is withdrawn out of the housing 50, supporting force between the key input part 100 and the panel housings 20 and 40 is weakened. Accordingly, to reinforce the weakened supporting force, the support 180 is provided between the panel housings 20 and 40 and the key input part 100.

The support 180 slides between the panel housings 20 and 40 and the key input part 100 along a support groove 180c. The support groove 180c may be also provided on the key input part 100.

FIG. 19c shows a view of the support. Support projections 180a and 180b are provided for the sliding motion.

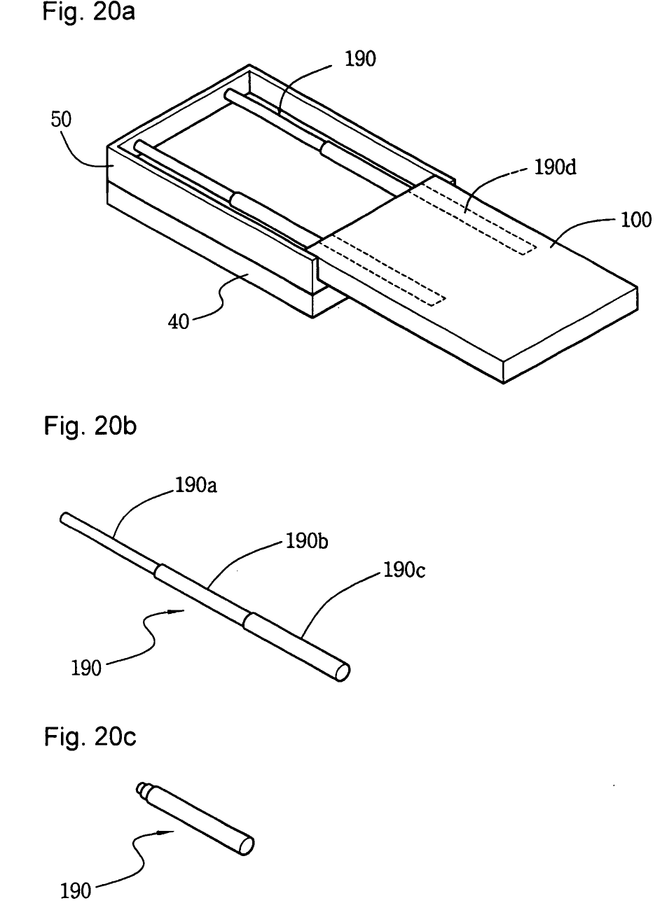

FIGS. 20a to 20c show another embodiment of the support.

In this embodiment, a support 190 is designed to be overlapped more than two stages. When the key input part 100 slides out of the panel housings 20 and 40, the support 190 is spread.

FIG. 20b shows a view of the support 190 spread, and FIG. 20c shows a view of the support 190 overlapped. The support 190 comprises three support cores 190a, 190b and 190c so that the support 190 can be overlapped in three stages.

Meanwhile, a plate-shaped support 190 can be provided between the lower portion of the panel housings 20 and 40 and the upper portion of the key input part 100. The plate-shaped support 190 also moves between the panel housings 20 and 40 and the key input part 100 in the sliding motion.

A feature of the present invention is to provide a multi display device having more than two foldable displays and the key input part 100. That is, when the displays are vertically adjacent to each other, the panel housings and the key input part are horizontally connected to each other. Accordingly, as shown in FIGS. 1 and 9, when the displays 2 and 4 and the key input part 100 are unfolded from each other, the displays 2 and 4 are sided toward one side of the key input part 100.

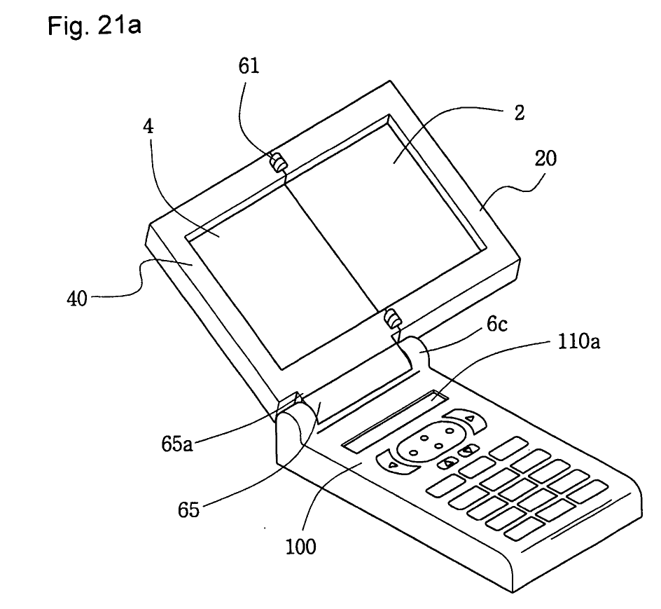

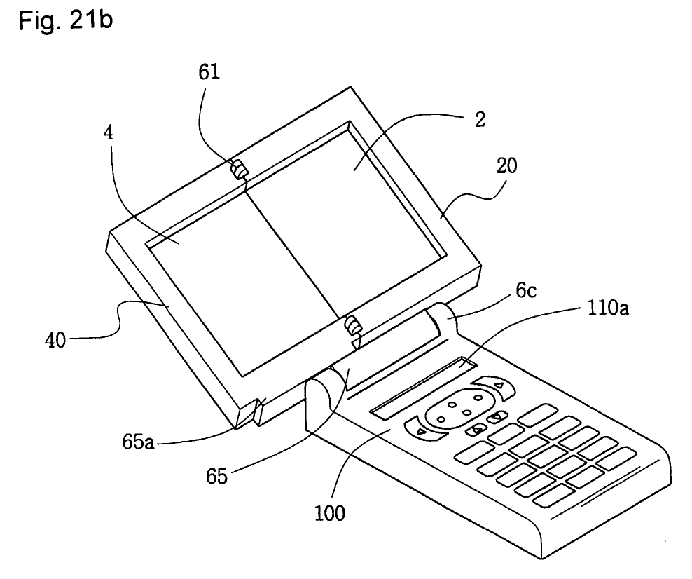

When the displays 2 and 4 are sided, the balance is not maintained, causing the user to feel the discomfort. Accordingly, to solve this problem, means for disposing the displays 2 and 4 on the center of the key input part is provided in the present invention. FIGS. 21 to 25 show a variety of embodiments of this means.

FIGS. 21a and 21b shows an embodiment where the displays move by a movable connection part.

As shown in FIG. 21a, when the key input part 100 and the displays 2 and 4 are unfolded, the displays 2 and 4 are sided toward one side of the key input part 100. To prevent this, this embodiment provides movable connection parts 65a and 65 to the panel housing 40 and the key input part 100, respectively.

The movable connection parts 65a and 65 relatively moves in a sliding motion to move the unfolded displays 2 and 4 to the center of the key input part 100.

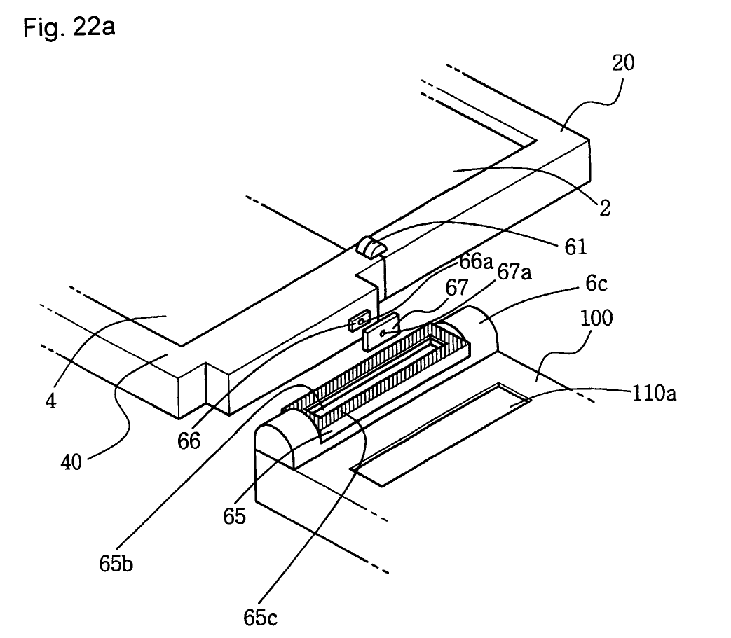

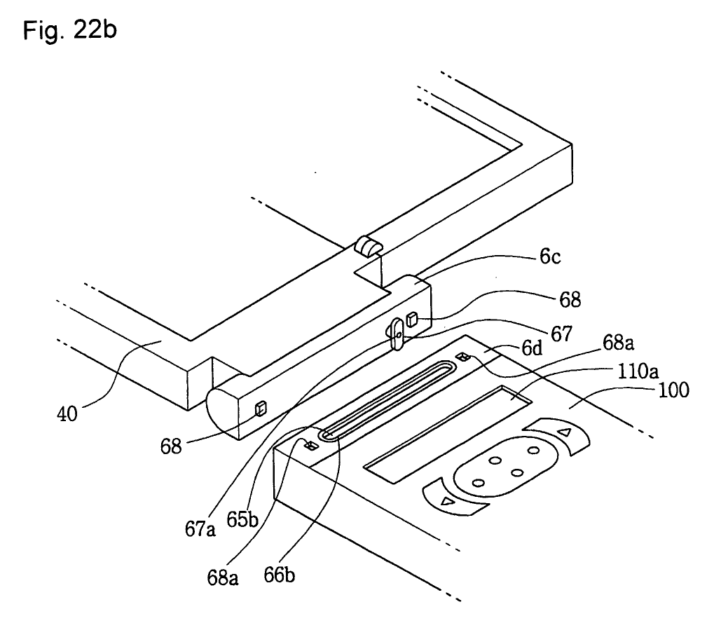

FIGS. 22a and 22b show a principle of the sliding of the unfolded displays.

The movable connection part 65 is provided on the connecting part 6c of the key input part 100, and the movable connection part 65 is provided with a longitudinal connection groove 65b. A connection projection 66 formed on the panel housing 40 slides along the connection groove 65b. In addition, a connection hook 67 is provided to prevent the connection projection 66 from removing out of the connection groove 65b. The connection projection and hook 66 and 67 are provided with connection holes 66a and 67a in which signal wires are inserted. The movable connection part 65 is provided with a sliding surface 65c.

The sliding surface 65c is formed of an elastic material such as a rubber or plastic to provide a seal effect. The sliding surface 65c is hard-coated with, for example, enamel resin to reduce friction during the sliding movement.

FIG. 22b shows an embodiment where the connecting part and a connection support slide.

In order to slide the connecting part 6c of the key input part 100 and a connection support 6d, the connection projection 66 and the connection hook 67 are provided in the connection groove 65b as well as the connection hole 67a and the sliding surface 66b. The operation principle is identical to that shown in FIG. 22a.

In addition, a hook groove 68a and a hook projection 68 are provided such that they can be engaged with each other after the sliding movement is completed. That is, when the unfolded displays 2 and 4 slides towards left or right ends, the hook grove 68a and the hook projection 68 are engaged one by one. At this point, the angled surface of the hook projection 68 is rounded so that the hook projection 68 can move in and out of the connecting part 6c.

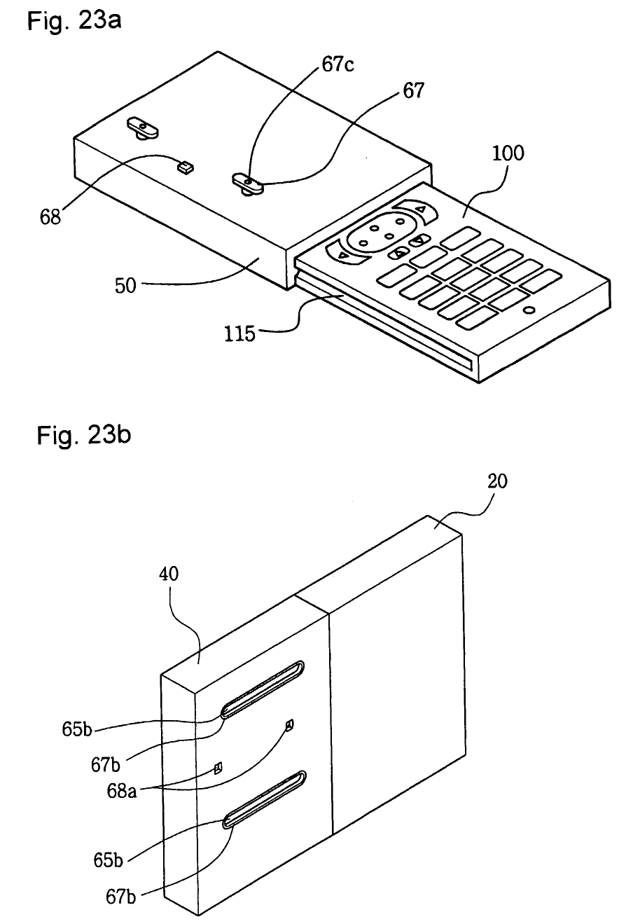

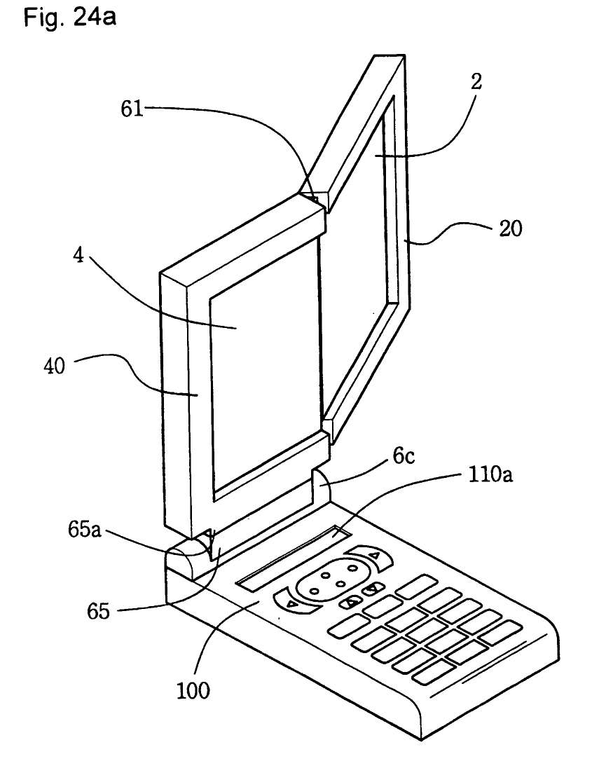

FIGS. 23a and 23b show an embodiment where the displays move to the central portion when the key input part slides. Showing the key input part 100 slides together with the panel housings 20 and 40. The unfolded displays 2 and 4 can moved to the center of the key input part 100.

FIG. 23a shows the housing and FIG. 23b shows the panel housings 20 and 40. There are provided the connection groove 65b, the connection projection 66, the connection hook 67, the connection hole 67c, and a sliding surface 67b, the operation of which is identical to that depicted in FIG. 22a. In addition, there are further provided the hook groove 68a and the hook projection 68, the operation of which is also identical to that depicted in FIG. 22b. By the operation of these parts, the unfolded displays 2 and 4 can slide to the center of the key input part 100.

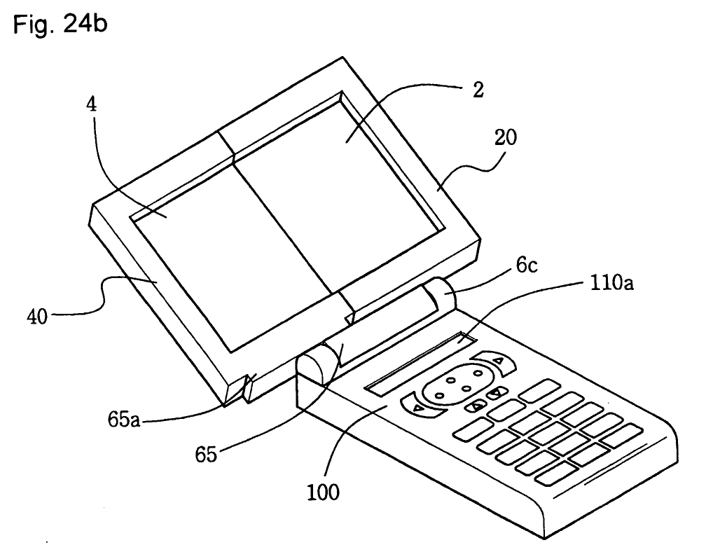

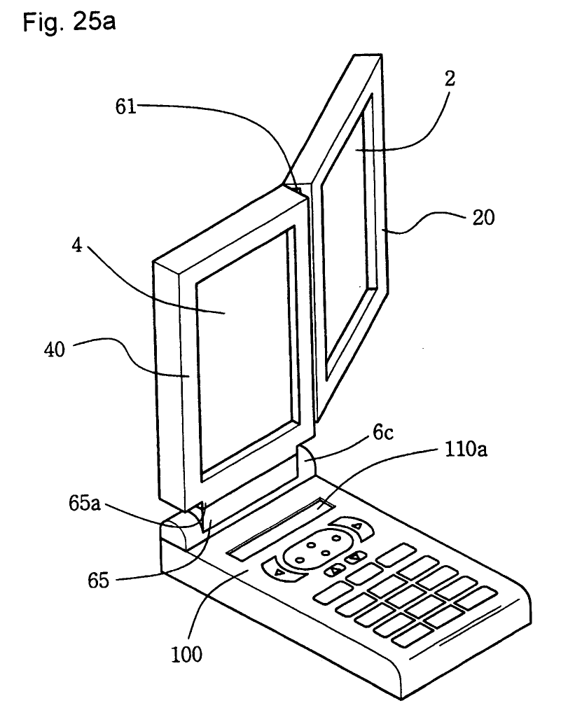

FIGS. 24a and 24b show an embodiment where the displays are folded on each other such that their rear surfaces contact each other.

FIG. 24a shows a view in which the displays are folded on their rear surfaces, in which the panel housings 20 and 40 with the displays 2 and 4 are completely folded rearward such that the rear surfaces of the displays 2 and 4 contact each other. When the panel housings 20 and 40 are unfolded, the display 2 and 4 are horizontally adjacent to each other.

FIG. 24b shows a view in which the display is moved to the center of the key input part 100 when the displays 2 and 4 are unfolded.

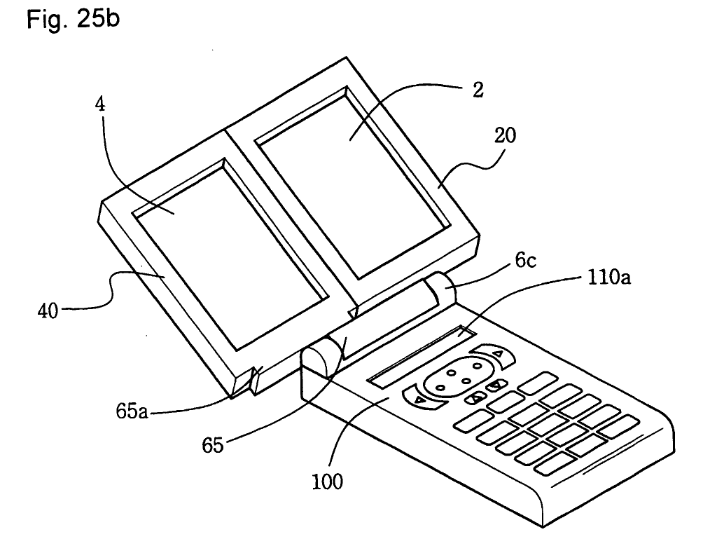

FIGS. 25a and 25b show another embodiment where the displays are folded rearward.

As shown in FIG. 25a, the panel housings 20 and 40 having the displays 2 and 4 are completely folded rearward such that rear surfaces of the displays 2 and 4 contact each other. However, when the panel housings 20 and 40 are unfolded, the displays 2 and 4 are not adjacent to each other since separated displays 2 and 4 are mounted on the panel housings 20 and 40, respectively.

FIG. 25b shows another embodiment where the displays 2 and 4 are moved to the center of the key input part.

Meanwhile, when the displays 2 and 4 are moved to the center of the key input part 100, the displays may be structured to be coupled to or separated from each other. In addition, the displays may be further structured to be overlapped or spread by the sliding motion.

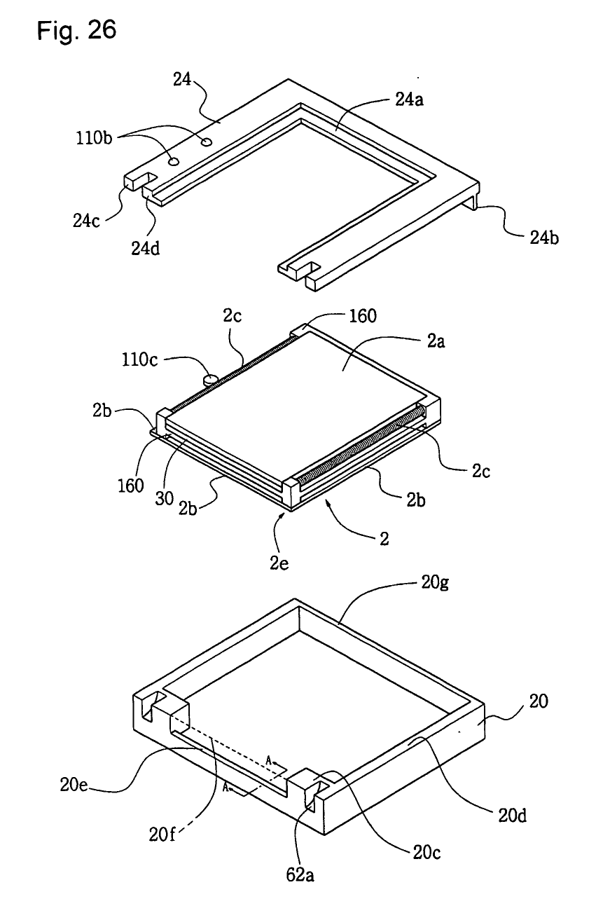

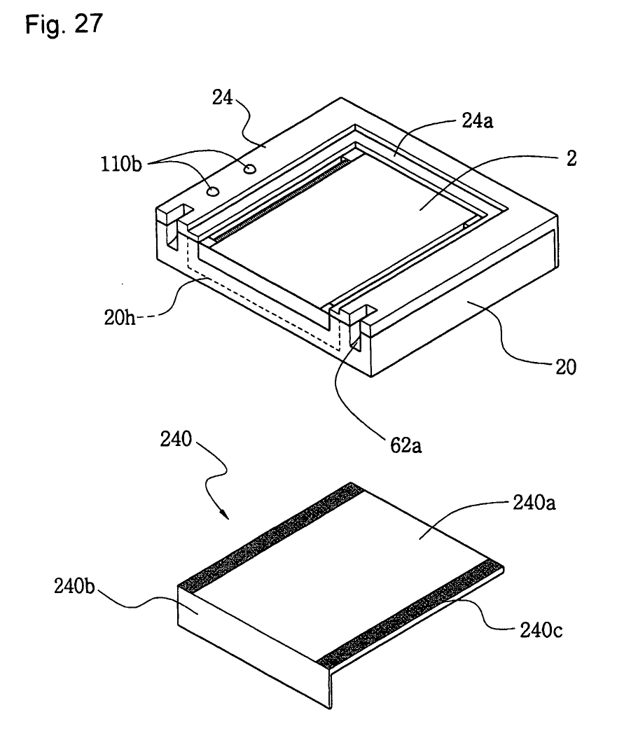

FIG. 26 shows a view illustrating the displays mounted in the panel housings.

Sidewalls 20d and 20g of the panel housings 20 may be designed having a different thickness. The panel housing 20 is provided with a connection shaft part 20c on which connecting means 61 and 62 are mounted and a connection shaft groove 62a. A connection joint part 20f is provided on a sidewall of the panel housings 20 and 40 where the adjacent portion of the displays 2 and 4 is located. In addition, by cutting the sidewall where the displays are adjacent to each other, a connection cutting portion 20e is formed. The displays 2 and 4 are mounted on an upper end of the connection cutting portion 20e.

When the displays 2 and 4 are adjacent to each other by the panel housings 20 and 40 closely contacting each, the displays 2 and 4 can be disposed adjacent to each other through the connection joint portion 20f.

The connection joint portion 20f is illustrated as a dotted-line in the drawing. The thickness of the connection joint portion 20f is designed to be thinner than other portions so that the displays 2 and 4 can be adjacent as close as possible. In addition, the connection joint portion 20f can be formed on an opening.

The display is comprised of a display panel 2a, a substrate 2b, a driving connection part 2c, and a diffuser 30, and mounted on a frame 160. An assembly of the parts and the frame 160 is called a module. A speaker 100c is connected to the module. The speaker may be provided to only one of the panel housings 20 and 40.

The adjacent of the displays means the adjacent of the modules. The adjacent portion 2e of the modules is illustrated in the drawing. The frame 160 of the adjacent part is opened. That is, an opposite of the adjacent portion 2e of the frame 160 has a predetermined thickness, while the adjacent portion 2e of the frame 160 is opened.

After the display is mounted on the panel housing such that the adjacent portion 2e of the module can be located on the upper end of the connection cutting portion 20e, it is covered by a cover 24. The cover 24 is provided with a cover step 24a for mounting the protecting cover. The cover 24 is provided a cover insertion portion 24b for fixing the cover 24 on the panel housing. The side of the cover is provided with steps 24c and 24d and speaker holes 110b. In the drawing, although two speaker holes 110b is provided, the number of the same is not limited to this. The location of the speaker holes 110b is determined in case the displays 2 and 4 are moved to the center of the key input part 100.

FIG. 27 shows a view illustrating the panel housing 20 with the display and the protecting cover.

As shown in the drawing, when the display 2 is mounted on the panel housing 20, it is covered by the cover 24, which is covered by the protecting cover 240. The protecting cover 240 is comprised of a front portion 240a and a side portion 240b. The front portion 240a is mounted on the cover step 24a to protect the front of the screen, and the side portion 240b is mounted on a side attaching portion 20h to protect the screen joint portion formed at an adjacent portion 2e of the panel housing 20. The side attaching portion 20h is shown as a dotted-line in the drawing and may be provided with a step.

The side portion 240b of the protecting cover is formed to be thinner than the front portion 240a. That is, the thickness of the side portion 240b is less than 0.5 mm so that the displays can be adjacent to each other as close as possible.

Meanwhile, the front portion 240a of the protecting cover is formed of a transparent material, while a side portion 240c is formed of a nontransparent material so that the driving connection part 2c cannot be seen.

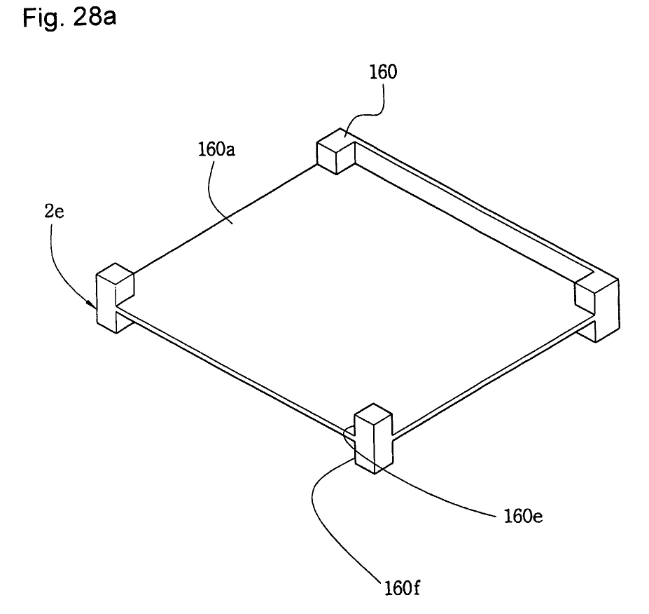

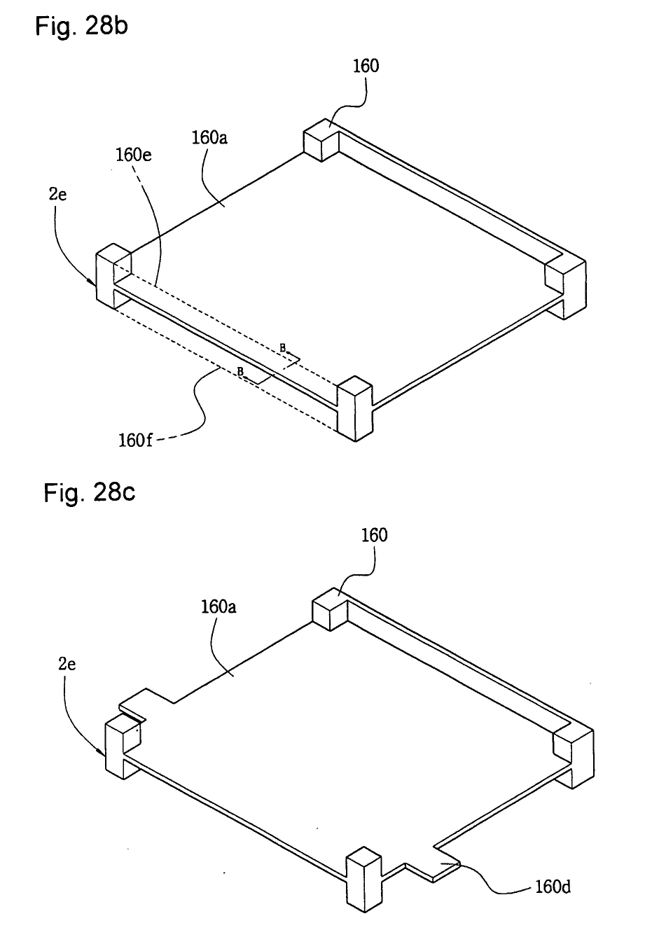

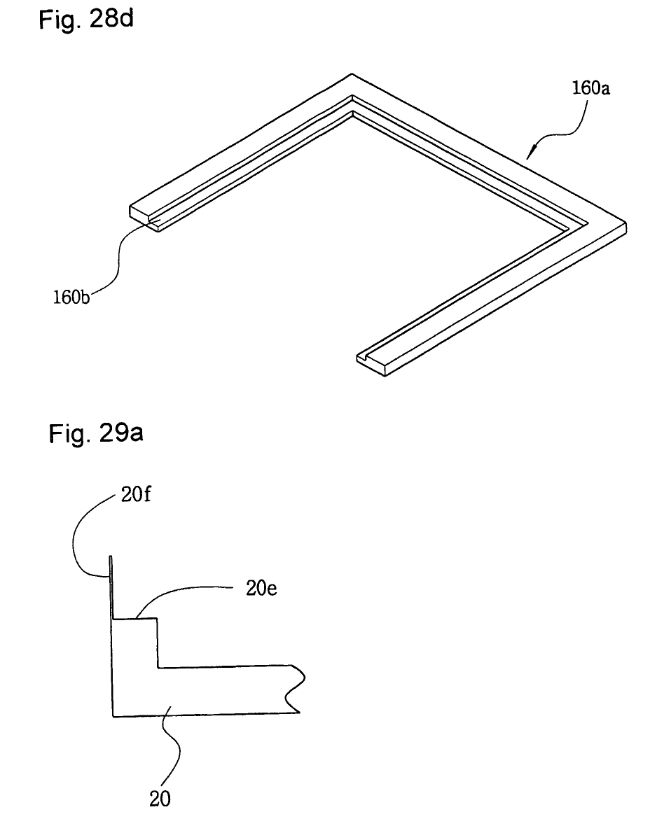

FIGS. 28a to 28d show the frame.

The frame on which the display panel 2a and the display circuits are mounted is also provided with connection joint portions 160e and 160f. The displays can be disposed adjacent to each other through the connection joint portions 160e and 160f that are also designed to be thinner than other portions or in an opening structure.

FIG. 28a shows that the connection joint portion formed on the adjacent portion 2e of the frame is opened. A portion of the connection joint portion on which the adjacent portion 2e of the frame 160 is opened, but an opposite portion is closed so that the displays 2 and 4 can be disposed adjacent to each other through the adjacent portion 2e. The display panel 2a and the diffuser 30 are mounted on a panel support 160a of the frame 160. The panel support 160a, the display panel and the diffuser are fixed by adhesive or hooking means.

FIG. 28b shows that the connection joint portions 160e and 160f formed on the adjacent portion 2e of the frame are formed to be thin. The connection joint portions 160e and 160f are formed to be thinner than other portions of the frame so that the displays 2 and 4 can be disposed adjacent to each other as close as possible.

In the present invention, since the display panel 2a and the driving substrate 2b are mounted on the frame, the structure of the frame 160 is designed in two layers. However, when only the display panel 2a is mounted, the frame 160 can be designed in a single layer. When the frame is designed in the single layer, only the reference numeral 160e becomes the connection joint portion.

FIG. 28c shows a view illustrating the frame 160 provided with a hook portion 160d. As shown in the drawing, the hook portion 160d is hooked on the connection shaft part 20c of the panel housing 20. That is, since there is a possibility that the display is removed in a direction of the adjacent portion 2e of the panel housings 20 and 40, the hook means is provided on the frame 160 to fix on the panel housings, thereby preventing the displays from removing in the direction of the adjacent portion 2e of the panel housings 20 and 40.

FIG. 28d shows another embodiment of the panel support 160a. A central portion representing the step is punctuated so that the diffuser can be mounted on the punctuated portion.

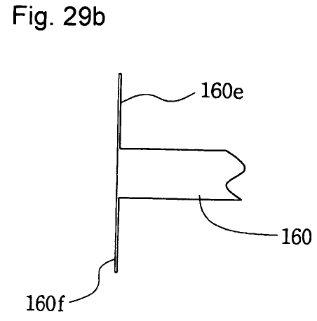

FIGS. 29a and 29b show a view of the connection joint portion of the panel housings and the frame.

FIG. 29a shows a sectional view of the connection joint portion 20f of the panel housing 20, taken along line crossing the panel housing in FIG. 26. The connection joint portion 20f is designed to be thinner than other portions of the panel housing, being less than 0.5 mm. The display is mounted on the connection cutting portion 20e.

FIG. 29b shows the connection joint portions 160e and 160f of the frame 160. Likewise, the connection joint portions 160e and 160f are also designed to be thinner than other portions of the frame 160, being less than 0.5 mm so as to dispose the displays as close as possible while protecting the sides of the displays 2 and 4.

### INDUSTRIAL APPLICABILITY

As described above, the multi display device of the present invention provides a specially prepared key input part in addition to the panel housings having displays that are horizontally adjacent to each other when the panel housings are unfolded. The key input part is designed to be overlapped on the panel housings by sliding or folding/unfolding motion.

In addition, when the panel housings are vertically adjacent to each other, the panel housings and the key input part are horizontally folded or slid. Accordingly, the multi display device is designed to be easy to grasp for the user while providing the folding/folding convenience.

1. A multi display device comprising:
panel housings having displays, the panel housings being foldable on each other, at least one side of the displays being disposed adjacent to each other when the panel housings are unfolded; and
a key input part foldable on the panel housings.

2. The multi display device of claim 1 wherein a gearing device or an elastic device is used to unfold the key input part from the panel housings or unfold the panel housings from each other.

3. The multi display device of claim 1 wherein the panel housings are unfolded from each other when the key input part is unfolded from the panel housings.

4. The multi display device of claim 1 further comprising a first sub-display formed on an outer surface of one of the panel housings folded on the key input part.

5. The multi display device of claim 1 further comprising a second sub-display formed on an inner surface of one of the panel housings unfolded from the key input part, the second sub-display being displayed an information by an input function provided on the key input part.

6. The multi display device of claim 5 wherein the second sub-display is driven when the key input part is unfolded from the panel housings folded from each other.

7. The multi display device of claim 1 further comprising cover means for covering a side folding portion of the panel housings, the cover means being provided on a side of the key input part where the a folding portion of the panel housings is mounted.

8. The multi display device of claim 1 further comprising an expanding part provided on the key input part, the expanding part being separately coupled on the key input part.

9. A multi display device comprising:
at least two panel housings with displays, the panel housings being foldable on each other, at least one side of the displays being disposed adjacent to each other when the panel housings are unfolded; and
a key input part insertable into a lower portion of the panel housings by a sliding motion.

10. The multi display device of claim 9 wherein the sliding motion of the key input part synchronizes with a folding/unfolding operation of the panel housings.

11. The multi display device of claim 9 further comprising a sub-display formed on an outer surface of the panel housing.

12. The multi display device of claim 9 wherein the key input part slides out when the panel housings are unfolded from each other.

13. The multi display device of claim 9 further comprising an expanding part separately coupled on the key input part.

14. The multi display device of claim 9 wherein the panel housings are overlapped on each other or spread from each other by a relative sliding motion, and when the panel housings are spread, at least one side of the displays are disposed adjacent to each other.

15. The multi display device of claim 9 wherein the panel housing are detachable coupled to each other, and when the panel housings are coupled to each other, at least one side of the displays are disposed adjacent to each other.

16. The multi display device of claim 9 further comprising a support for enhancing supporting force between the key input part and the panel housings when the key input part slides out of the panel housings.

17. The multi display device of claim 16 wherein the support is designed slide between the panel housings and the key input part or designed in more than two steps so that they can be overlapped.

18. A multi display device comprising:
at least two panel housings with displays, the panel housings being foldable on each other, at least one side of the displays being disposed adjacent to each other when the panel housings are unfolded;
a key input part; and
means for moving the displays to a center of the key input part when the displays are sided to one side of the key input part when the key input part and the displays are unfolded from each other.

19. The multi display device of claim 18 wherein the panel housings and the key input part are moved by a folding/unfolding operation or a relative sliding motion.

20. The multi display device of claim 18 wherein the displays are folded such that rear surfaces of the displays contact each other and designed to be adjacent to each other or separated from each other when the displays are unfolded.

21. A multi display device comprising:
at least two panel housings with displays, the panel housings being foldable on each other, at least one side of the displays being disposed adjacent to each other when the panel housings are unfolded;
a key input part; and
a connection joint portion formed on a sidewall of the panel housing to which the displays adjacent or an adjacent portion of a frame to which the displays adjacent so as to dispose the displays to be adjacent to each other.

22. The multi display device of claim 21 wherein the connection joint portion is opened.

23. The multi display device of claim 21 wherein a thickness of the connection joint portion is less than 0.5 mm.

24. The multi display device of claim 21 wherein a sidewall of the panel housings where the displays are adjacent to each other is cut away to defining a cutting portion and the displays are mounted on the upper end of the cutting portion.

25. The multi display device of claim 21 wherein after mounting the displays on the panel housings, a protecting cover is disposed to protect the connection joint portion of the panel housing and a front of a screen.

26. The multi display device of claim 25 wherein the protecting cover has a side protecting part for protecting the connection joint portion of the panel housings and a front protecting part for protecting the front of the screen, the side protecting part being thinner than the front protecting part.

27. The multi display device of claim 25 wherein a thickness of the side protecting part is less than 0.5 mm.
